(19) United States
(12) Patent Application Publication
(10) Pub. No.: US 2003/0152325 A1
(43) Pub. Date: Aug. 14, 2003

(54) Optical module

(76) Inventors: Yoshihide Yasuda, Osaka-shi (JP); Yoshiro Sato, Osaka-shi (JP); Minoru Taniyama, Osaka-shi (JP); Kenjiro Hamanaka, Osaka-shi (JP)

Correspondence Address: FISH & RICHARDSON PC, 225 FRANKLIN ST, BOSTON, MA, 02110, US

(21) Appl. No.: 10/366,997

(22) Filed: Feb. 14, 2003

(30) Foreign Application Priority Data
Feb. 14, 2002 (JP) 2002-037139

(51) Int. Cl. G02B 6/32

(52) U.S. Cl. 385/33

(57) ABSTRACT

An optical module includes a planar microlens having a lens substrate and a microlens body. The microlens body is arranged in one end face of the lens substrate and has an optical axis. The optical module further includes an optical fiber having a core axis and an emission end face. The emission end face is inclined relative to the core axis. The optical fiber and the planar microlens are spaced apart by a predetermined distance such that the optical fiber emits light that enters the microlens body at a point that lies along the optical axis of the microlens body and travels along the optical axis.

### BACKGROUND OF THE INVENTION

The present invention relates to an optical module that includes a planar microlens and an optical fiber.

An optical module including a planar microlens, which has a microlens body formed on one of its end faces, and an optical fiber, which has an emission end face inclined relative to the core axis, is known in the prior art. Such an optical module is used for optical communications, and optically couples the light emitted from the optical fiber to other components, such as another optical fiber or a light-receiving device, with the planar microlens.

FIGS. 6 to 8 each shows an example of a prior art optical module. The optical module shown in FIG. 6 includes a planar microlens 11, which has a microlens body 12 in its left end face (lens face) 11a of FIG. 6, and an optical fiber 13, which has an emission end face 13a that is ground to be inclined relative to the core axis. The optical fiber 13 and the planar microlens 11 are arranged such that the emission end face 13a of the optical fiber 13 and the left end face 11a of the planar microlens 11 are opposed to each other and the core axis of the optical fiber 13 and the optical axis of the microlens body 12 are aligned with each other.

In the optical module shown in FIG. 7, the core axis of the optical fiber 13 is separated from the optical axis of the planar microlens 11 by a predetermined distance such that the light emitted from the emission end face 13a of the optical fiber 13 is emitted from the planar microlens 11 parallel to the optical axis of the planar microlens 11.

In the optical module shown in FIG. 8, the core axis of the optical fiber 13 is separated from the optical axis of the microlens body 12 by a predetermined distance such that the light emitted from the emission end face 13a of the optical fiber 13 enters the center of the microlens body 12. In the optical module of FIG. 8, the distance between the core axis of the optical fiber 13 and the optical axis of the microlens body 12 differs from that in the optical module of FIG. 7. For this reason, in the prior art optical modules of FIGS. 7 and 8, the light is emitted at different angles relative to the optical axis of the planar microlens 11.

The prior art optical modules shown in FIGS. 6 to 8 have the following problems.

(1) In the prior art example shown in FIGS. 6 to 8, the light emitted from the optical fiber 13 is separated from the optical axis of the microlens body 12 when traveling through the microlens body 12. Therefore, the emitted light may be affected by aberration of the microlens body 12.

(2) In the prior art examples shown in FIGS. 6 and 7, the optical fiber 13 emits light that enters the planar microlens 11 at a point separated from the optical axis of the microlens body 12. In such a case, the alignment and the positioning of the optical fiber 13 and the planar microlens 11 is difficult. This consumes time and decreases yield.

(3) In the prior art example shown in FIGS. 6 and 8, the light emitted from the microlens body 12 is inclined relative to the optical axis of the microlens body 12. Therefore, it is difficult to manufacture a collimator module using two fiber collimators, each being formed from the optical fiber 13 and the planar microlens 11. If the light emitted from the microlens body 12 is inclined relative to the optical axis, the two fiber collimators must be inclined relative to each other. Alternatively, each fiber collimator and components attached to the collimator must be inclined relative to each other. In addition, when the inclination angle of the emitted light is large, a large space is required for arranging the parts.

(4) In the above prior art example, each microlens body 12 has a small lens diameter. Thus, when the distance between the optical fiber 13 and the planar microlens 11 is great, the eclipse relative to the incident light increases. This increases the transmission loss of the light.

In this manner, it is difficult to simultaneously optimize the position, at which light enters the microlens body 12, and the direction, in which light is emitted from the microlens body 12.

Accordingly, it is an object of the present invention to provide an optical module that minimizes the adverse effects on the emitted light that result from the lens aberration and reduces light transmission loss.

### SUMMARY OF THE INVENTION

To achieve the above object, the present invention provides an optical module including a planar microlens including a lens substrate and a microlens body. The lens substrate includes an end face with the microlens body arranged in the end face and the microlens body has an optical axis. An optical fiber includes a core axis and an emission end face, with the emission end face inclined relative to the core axis. The optical fiber and the planar microlens are spaced by a predetermined distance such that the optical fiber emits light that enters the microlens body at a point that lies along the optical axis of the microlens body and travels along the optical axis.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross sectional view showing a collimator according to a first embodiment of the present invention;

FIG. 2 is a perspective view showing a collimator array according to a second embodiment of the present invention;

FIG. 3 is a cross sectional view showing the collimator of the second embodiment;

FIG. 4 is a cross sectional view showing a collimator according to a third embodiment of the present invention;

FIG. 5 is a cross sectional view showing a collimator according to a fourth embodiment of the present invention;

FIG. 6 is a cross sectional view showing a prior art example of a collimator;

FIG. 7 is a cross sectional view showing a further prior art example of a collimator; and

FIG. 8 is a cross sectional view showing a further prior art example of a collimator.

### DETAILED DESCRIPTION OF THE PREFERRED EMBODIMENTS

First to fifth embodiments of an optical module according to the present invention that are applied to a fiber collimator will now be described with reference to the drawings. In the description of the embodiments, like numerals are used for like elements and will be described only once.

FIG. 1 shows an optical module 20 according to the first embodiment of the present invention. The optical module 20 includes a planar microlens 21 and an optical fiber 22. The optical fiber 22 has an emission end face 22a. The emission end face 22a is ground so that it is inclined relative to a plane, which is perpendicular to the core axis C1, at a predetermined angle (e.g., 8°) to prevent reflected light from returning to a light source on the opposite side of the emission end face 22a.

The planar microlens 21 includes a transparent lens substrate 23 and a microlens body 24, which is arranged in a right end face 23a of the substrate 23, as viewed in FIG. 1. Ion exchange is performed so that the microlens body 24 has generally semispherical cross section and a predetermined gradient index.

The right end face 23a of the lens substrate 23 extends vertically relative to an optical axis C2 of the microlens body 24. A left end face 23b of the lens substrate 23 is ground so that it is inclined relative to a plane, which is perpendicular to an optical axis C2, at a predetermined angle (e.g., 8°) to prevent reflected light from returning to a light source.

The planar microlens 21 is formed so that length D of the lens substrate 23 in the optical axis direction of the microlens body 24 is shorter than or substantially equal to the focal length f of the microlens body 24.

When manufacturing the optical module 20, the optical fiber 22 and the planar microlens 21 are arranged close to each other so that the optical fiber 22 emits light that enters the planar microlens at a point that lies along the optical axis C2 of the microlens body 24, and travels along the optical axis C2.

In the optical module 20, the light emitted from the emission end face 22a of the optical fiber 22 enters the left end face 23b of the lens substrate 23 at a point that lies along the optical axis C2 (the position denoted by A in FIG. 1), and travels along the optical axis C2. The length D of the lens substrate 23 is shorter than or substantially equal to the focal length f of the microlens body 24. Thus, the incident light is converted into parallel light and emitted from the planar microlens 21 along the optical axis C2. In this state, the incident light travels through substantially the center of the lens body 24 and the light is emitted without being inclined relative to the optical axis C2.

The first embodiment has the advantages described below.

(1) The light emitted from the optical fiber 22 travels through the planar microlens 21 along the optical axis C2. This minimizes the affect of aberration of the microlens body 24.

(2) The optical fiber 22 emits light that enters at a point that lies along the optical axis C2 of the microlens 21, and travels along the optical axis C2. Thus, the alignment and positioning of the optical fiber 22 and the planar microlens 21 is facilitated. This saves time and increases yield.

(3) Light is emitted from the planar microlens 21 along the optical axis C2. Accordingly, the manufacturing of a collimator module is facilitated when using two optical modules 20, each being formed from the planar microlens 21 and the optical fiber 22. That is, the two optical modules 20 may be easily positioned so that the optical axes of the optical modules 20 lie on the same plane. In addition, the optical modules 20 and components attached to each optical module 20 do not have to be inclined relative to each other. This facilitates the manufacturing of a collimator module.

(4) The optical fiber 22 emits light that enters the microlens body 24 at a point lying along the optical axis C2. Therefore, even if the microlens body 24 has a small diameter, the eclipse produced by the planar microlens 21 is small. This reduces the transmission loss of light.

(5) The optical fiber 22 emits light that enters the planar microlens 21 at a point lying along the optical axis C2 of the planar microlens 21 and exits the planar microlens 21 along the optical axis C2. This enables simultaneous adjustment of the position where the light enters the planar microlens 21 and the direction of the light emitted from the planar microlens 21.

(6) The length D of the lens substrate 23 in the optical axis direction of the microlens body 24 is shorter than or equal to the focal length f of the microlens body 24. Accordingly, the gap between the optical fiber 22 and the planar microlens 21 may be narrowed. This reduces size of the entire optical module 20 in the optical axis direction and enable the manufacturing of a more compact optical module.

(7) The microlens 21 is manufactured by arranging the microlens body 24 in the right end face 23a of the lens substrate 23 and inclining the left end face 23b of the lens substrate 23. Accordingly, the planar microlens 21 is manufactured with a small number of components at a lower cost.

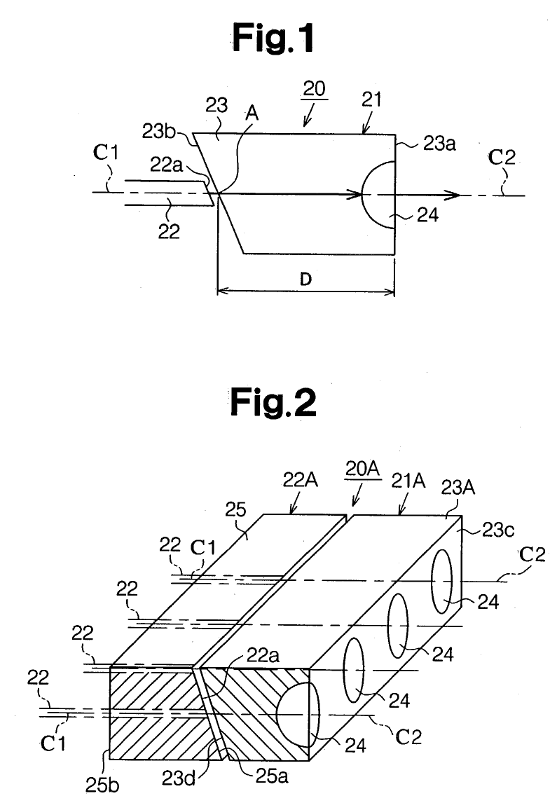

FIG. 2 shows an optical module 20A, which serves as a fiber collimator, according to the second embodiment of the present invention. The optical module 20A includes a planar microlens array 21A and an optical fiber array 22A.

The planar microlens array 21A includes a lens substrate 23A, which is similar to the lens substrate 23, and four microlens bodies 24, which are located in a right end face 23c of the lens substrate 23A. In FIG. 2, the cross section extending through the center of the nearmost microlens body 24 is shown. The four microlens bodies 24 are arranged in a line such that the optical axes C2 of the four microlens bodies 24 extend parallel to each other along the same plane. A left end face 23d of the lens substrate 23A inclines relative to a plane, which is perpendicular to the optical axis C2, at an angle of 8°.

The optical fiber array 22A has four of the optical fibers 22 of the first embodiment corresponding to the microlens bodies 24, respectively. A capillary 25 holds the optical fibers 22 such that the core axes C1 of the optical fibers 22 extend parallel to each other along the same plane. Among the two end faces of the capillary 25, a right end face 25a facing the left end face 23d of the lens substrate 23A is flush with an emission end face 22a of each optical fiber 22 and is ground to be inclined relative to a plane, which is perpendicular to the core axes C1, at an angle of 8°. A left end face 25b of the capillary 25 extends perpendicular to the core axes C1. Each of the optical fibers 22 is fixed to the capillary 25 with an adhesive agent.

In the planar microlens array 21A, the length D of the lens substrate 23A in the optical axis direction of each microlens body 24 is shorter than or substantially equal to the focal length f of the microlens body 24.

When manufacturing the optical module 20A, the optical fiber array 22A and the planar microlens array 21A are positioned such that each optical fiber 22 emits light that enters the associated microlens body 24 at a point lying along the corresponding optical axis C2, and travels along the optical axis C2.

In the optical module 20A manufactured as described above, the light emitted from the emission end face 22a of each optical fiber 22 enters the left end face 23d of the lens substrate 23A of the planar microlens array 21A at a point lying along the corresponding optical axis C2, and travels along the optical axis C2. The incident light is emitted from each microlens body 24 of the planar microlens array 21A along the corresponding optical axis C2.

The second embodiment has the advantages described below in addition to the advantages (1) to (7), which are described above.

(8) By aligning the optical fiber array 22A and the planar microlens array 21A once, the plurality of optical fibers 22 and the plurality of microlens bodies 24 may be positioned at the optimal positions. This facilitates assembly when manufacturing a module from the optical fiber array 22A and the planar microlens 21A.

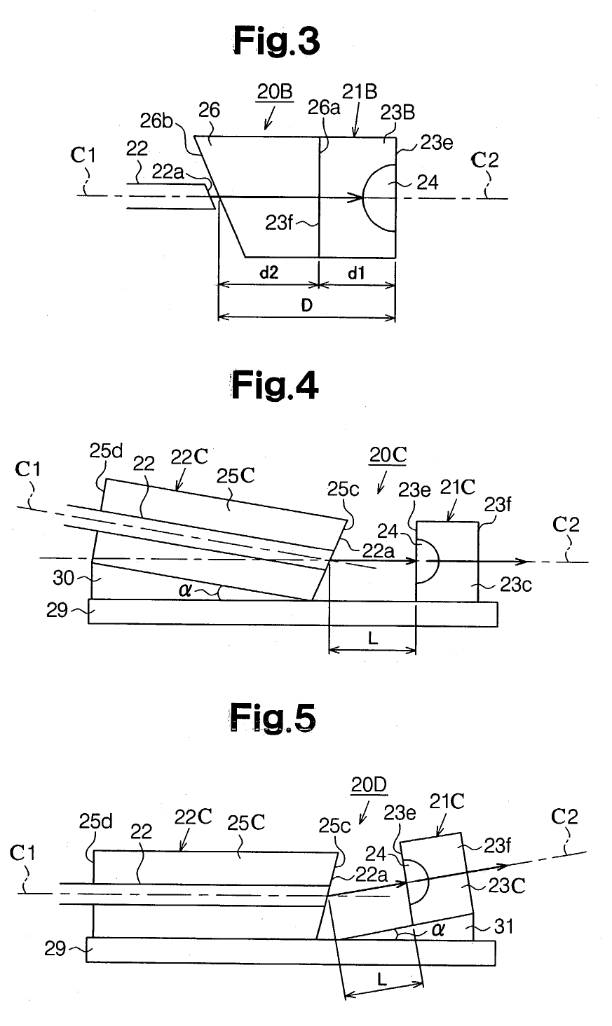

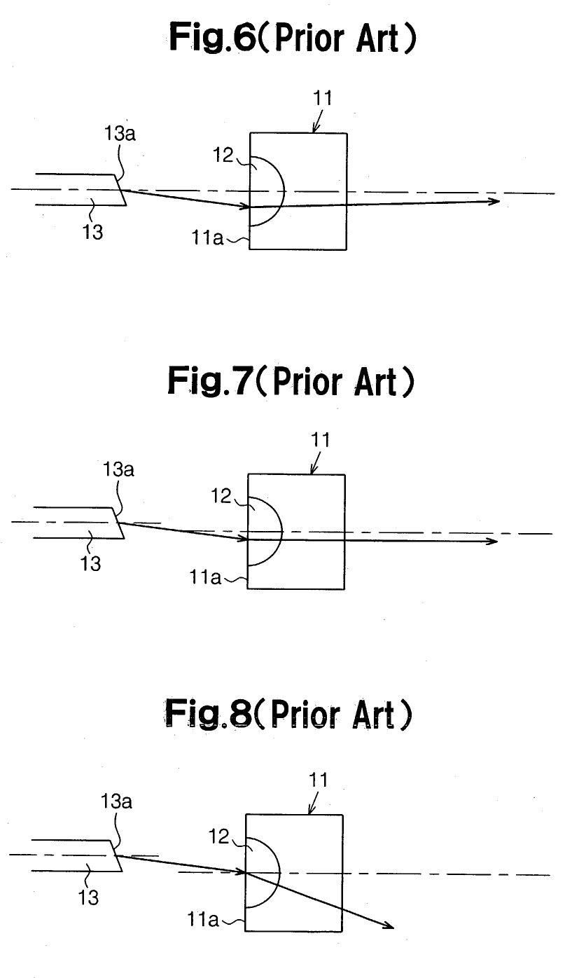

FIG. 3 shows an optical module 20B of the third embodiment of the present invention that is used as a fiber collimator. In the third embodiment, a planar microlens 21B includes a transparent lens substrate 23B and a transparent spacer 26, which is connected to the lens substrate 23B. The lens substrate 23B has two end faces 23e and 23f, which are perpendicular to the optical axis C2 of a microlens body 24. The microlens body 24 is arranged in the right end face 23e of the lens substrate 23B. The spacer 26 is wedge-like and has a right end face 26a, which is connected to the left end face 23f of the lens substrate 23B, and a left end face 26b, which is inclined relative to the right end face 26a at a predetermined angle (e.g., 8°).

The sum D of the length d1 of the lens substrate 23B and the length d2 of the spacer 26 in the optical axis direction of the microlens body 24 is shorter than or equal to the focal length f of the microlens body 24.

The third embodiment has the advantages described below in addition to the previously described advantages (1) to (6), which are described above.

(9) The left end face 26b of the spacer 26, which faces the inclined emission end face 22a of the optical fiber 22, is ground so that it is parallel to the emission end face 22a. Therefore, the end face of the lens substrate 23B need not be ground to be inclined. This prevents the planar microlens 21B from being damaged when grinding the end face of the lens substrate 23B.

FIG. 4 shows an optical module 20C of the fourth embodiment of the present invention that is used as a fiber collimator. The optical module 20C includes a planar microlens array 21C, an optical fiber array 22C, and a wedge-like spacer 30. The planar microlens array 21C includes a transparent lens substrate 23C, which has two parallel end faces 23e and 23f. A plurality of microlens bodies 24 are arranged in the left end face 23e.

The optical fiber array 22C has optical fibers 22, the number of which is same as that of the microlens bodies 24. A capillary 25C holds the optical fibers 22 so that their core axes C1 are parallel to each other. Among the two end faces of the capillary 25C, a right end face 25c is opposed to the left end face 23e of the lens substrate 23C. The right end face 25c is ground to be inclined relative to a plate, which is perpendicular to each core axis C1, at an angle of 8° such that the right end face 25c is flush with an emission end face 22a of each optical fiber 22. A left end face 25d of the capillary 25C is perpendicular to each core axis C1. The optical fibers 22 are fixed to the capillary 25C with an adhesive agent.

The optical fiber array 22C is placed on a block 29 by means of the wedge-like spacer 30, which is connected to the optical fiber array 22C. The inclination angle α of the spacer 30 is determined so that the optical fiber array 22C and the planar microlens array 21C are aligned with each other when the optical fiber array 22C is spaced from the planar microlens array 21C by a distance L, which corresponds to the focal length f of the microlens body 24.

When the optical fiber array 22C and the planar microlens array 21C are located at the alignment positions, each optical fiber 22 of the optical fiber array 22C emits light that enters the left end face 23e of the planar microlens array 21C at a point lying along the optical axis of the corresponding microlens body 24, and travels along the optical axis.

When assembling the optical module 20C, the planar microlens array 21C is placed on the block 29. The optical fiber array 22C is placed on the block 29 together with the spacer 30. Accordingly, the optical fiber array 22C is inclined relative to the block 29 at a predetermined angle. As a result, the optical fiber array 22C is held in a state inclined relative to the planar microlens array 21C at a predetermined angle.

In this state, the positions of the optical fiber array 22C and the planar microlens array 21C are adjusted such that the distance L between the optical fiber array 22C and the planar microlens array 21C becomes equal to the focal length f of the microlens body 24. At the adjusted positions, the spacer 30 and the lens substrate 23C are fixed to the block 29 with an adhesive agent. This completes the optical module 20.

In the optical module 20C manufactured as described above, each optical fiber 22 of the optical fiber array 22C emits light that enters the left end face 23e of the lens substrate 23C at a point lying along the optical axis C2 of the corresponding microlens body 24, and travels along the optical axis C2. Since the optical fiber array 22C is spaced from the planar microlens array 21C by the distance L that is equal to the focal length f, each incident light is converted into parallel light by the microlens body 24 and is emitted from the planar microlens 21 along the optical axis C2.

The fourth embodiment has the advantages described below.

(10) The relative inclination angles between the optical fibers 22 and the microlens bodies 24 are determined simultaneously by the capillary 25C and the wedge-like spacer 30. This facilitates assembly of a fiber collimator (optical module) that is formed from the optical fiber array 22C, which includes the plurality of optical fibers 22, and the planar microlens array 21C, which includes the plurality of microlens bodies 24.

(11) The optical fiber array 22C is spaced from the planar microlens array 21C by the distance L, which is equal to the focal length f. Therefore, the light emitted from each optical fiber 22 is converted into parallel light by the associated microlens body 24 and emitted from the planar microlens array 21.

FIG. 5 shows an optical module 20D according to the fifth embodiment of the present invention used as a fiber collimator. In the fourth embodiment shown in FIG. 4, the wedge-like spacer 30 inclines the optical fiber array 22C relative to the block 29 at a predetermined angle. In contrast, in the optical module 20D of the fifth embodiment, another wedge-like spacer 31 having the same inclination angle α as that of the above wedge-like spacer 30 inclines a planar microlens array 21C relative to a block 29 at a predetermined angle.

The inclination angle α of the spacer 31 is determined so that the optical fiber array 22C and the planar microlens array 21C are aligned with each other when the optical fiber array 22C and the planar microlens array 21C are spaced by a distance L, which corresponds to the focal length f of the microlens body 24.

The remaining structure is the same as the fourth embodiment.

Accordingly, the fifth embodiment has the same advantages as those of the fourth embodiment.

It should be apparent to those skilled in the art that the present invention may be embodied in many other specific forms without departing from the spirit or scope of the invention. Particularly, it should be understood that the present invention may be embodied in the following forms.

In the first embodiment, a capillary may be employed to hold the optical fiber 22. In this case, the optical module 20 may be formed by connecting the capillary and the planar microlens 21.

In the first embodiment, the emission end face 22a of the optical fiber 22 and the left end face 23b of the lens substrate 23 are each inclined at 8°. However, they may be inclined at an angle other than 8°. This is the same with regard to the inclination angle of the emission end face 22a and the left end face 23d of the lens substrate 23A in the second embodiment and the left end face 26b of the spacer 26 in the third embodiment. Further, this is the same with regard to the emission end face 22a and the right end face 25c of the capillary 25C in the fourth and fifth embodiments.

In the second embodiment, the number of the microlens bodies 24 and the optical fibers 22 is not limited to 4 and may be any number.

In the fourth embodiment, the wedge-like spacer 30 is used to incline the capillary 25C relative to the planar microlens 21B at a predetermined angle. However, other components may be employed instead of the spacer. This is the same with regard to the wedge-like spacer 31 in the fifth embodiment.

In the fourth and fifth embodiments, a capillary may be used for each optical fiber 22 instead of using the capillary 25C that holds the plurality of optical fibers 22. Instead of the planar microlens array 21C, a planar microlens having a microlens body 24 formed in the left end face 23e of the lens substrate 23C may be employed.

The present examples and embodiments are to be considered as illustrative and not restrictive, and the invention is not to be limited to the details given herein, but may be modified within the scope and equivalence of the appended claims.

What is claimed is:

1. An optical module comprising:
a planar microlens including a lens substrate and at least one microlens body, the lens substrate including an end face with the microlens body arranged in the end face and the microlens body having an optical axis; and
an optical fiber including a core axis and an emission end face, with the emission end face inclined relative to the core axis, the optical fiber and the planar microlens being spaced by a predetermined distance such that the optical fiber emits light that enters the microlens body at a point that lies along the optical axis of the microlens body and travels along the optical axis.

2. The optical module according to claim 1, wherein the microlens body includes a focal length and the length of the planar microlens in the optical axis direction is shorter than or equal to the focal length of the microlens body.

3. The optical module according to claim 1, wherein the lens substrate is transparent and said end face is a first end face, which is perpendicular to the optical axis of the microlens body, and the lens substrate includes a second end face, which is opposed to the emission end face of the optical fiber inclined at the same angle as the emission end face.

4. The optical module according to claim 1, wherein the lens substrate is transparent and said end face is a first end face and the lens substrate includes a second end face with the end faces each perpendicular to the optical axis of the microlens body, the planar microlens including a transparent spacer connected to the second end face and the spacer including a spacer end face inclined parallel to the emission end face of the optical fiber.

5. An optical module comprising:
a planar microlens array including a lens substrate and a plurality of microlens bodies, the lens substrate including an end face with the microlens bodies each arranged in the end face and each microlens body having an optical axis parallel to the optical axis of each of the microlens body; and
a plurality of optical fibers, each having a core axis and an emission end face, with the optical fibers respectively arranged in correspondence with the microlens bodies, and the emission end face of each optical fiber inclined relative to the core axis of the optical fiber, and the optical fibers and the planar microlens array arranged such that each optical fiber emits light that enters the corresponding microlens body at a point that lies along the optical axis of the microlens body and travels along the optical axis thereof.

6. The optical module according to claim 5, further comprising a capillary supporting each optical fiber.

7. An optical module comprising:
a planar microlens including a lens substrate and a microlens body, the lens substrate including an end face with the microlens body arranged in the end face and the microlens body having an optical axis;
an optical fiber including a core axis and an emission end face, with the emission end face inclined relative to the core axis;
a capillary holding the optical fiber and having an inclined surface that is flush with the emission end face of the optical fiber;
a block supporting the capillary and the planar microlens; and
a spacer holding one of the capillary and the planar microlens at an inclination relative to the block, and the optical fiber and the planar microlens are arranged such that the optical fiber emits light that enters the microlens body at a point lying along the optical axis of the microlens body and travels along the optical axis.

8. The optical module according to claim 7, wherein the microlens body includes a focal length and the emission end face of the optical fiber is spaced from the microlens body by a distance smaller than or equal to the focal length of the microlens body.

9. An optical module comprising:
a planar microlens including a lens substrate and a plurality of microlens bodies, the lens substrate including an end face with the microlens bodies each arranged in the end face and each microlens body having an optical axis parallel to the optical axis of each of the microlens body;
an optical fiber corresponding to each microlens body, each optical fiber having a core axis and an emission end face, with the emission end face of each optical fiber inclined relative to the core axis of the optical fiber;
a capillary holding the optical fibers and having an inclined surface flush with the emission end faces of the optical fibers;
a block supporting the capillary and the planar microlens; and
a spacer holding one of the capillary and the planar microlens at an inclination relative to the block, the optical fibers and the planar microlens arranged such that each optical fiber emits light that enters the corresponding microlens body at a point lying along the optical axis thereof and travels along that optical axis.

10. The optical module according to claim 9, wherein each microlens body includes a focal length, the focal lengths of the microlens bodies being equal, and the capillary and the planar microlens are placed on the block and spaced apart by a distance that is equal to said focal length.
